(19) United States
(12) Patent Application Publication
(10) Pub. No.: US 2024/0140306 A1
(43) Pub. Date: May 2, 2024

(54) SYSTEM AND METHOD OF ILLUMINATING AUTOMOTIVE FLOOR MATS

(71) Applicant: Steve Anderson, West Jordan, UT (US)

(72) Inventor: Steve Anderson, West Jordan, UT (US)

(21) Appl. No.: 18/497,873

(22) Filed: Oct. 30, 2023

Related U.S. Application Data
(60) Provisional application No. 63/381,497, filed on Oct. 28, 2022.

(51) Int. Cl. B60Q 3/20; B60N 3/04; B60Q 3/60; B60Q 3/80; H02J 50/10; H02J 50/40

(52) U.S. Cl. CPC B60Q 3/20; B60N 3/048; B60Q 3/60; B60Q 3/80; H02J 50/10; H02J 50/40

(57) ABSTRACT

The present invention is a system and method for providing a floor mat that uses wireless powering of a floor mat lighting system disposed within the floor mat. Instead of requiring precise alignment of the floor mat with a wireless power transmitter, the floor mat may be positioned in a general area and will tolerate movement of the floor mat that will not interrupt power flow.

### BACKGROUND

Field of the Invention: This invention relates generally to floor mats for use in cars, trucks, boats or any other types of vehicles where a floor mat or a cargo mat may be disposed. More specifically, the invention pertains to a system and method for illuminating a floor mat using LED lights that are disposed within the floor mat, and how power may be provided to the floor mat using wireless power transfer technology.

Description of Related Art: The prior art teaches several examples of illuminated floor mats that are used for decorative and functional lighting. These floor mats are shown with lighting systems that are able to provide illumination, decoration, and branding to the occupants of a vehicle, along with the protection that the floor mats offer for the floor of the vehicle.

The prior art teaches several useful features when providing an illuminated floor mat. For example, some prior art teaches the aspect of using inductive coupling to enable wireless powering or wireless charging of the lights in a floor mat. However, the prior art examples all require precise positioning of the floor mat in order to be coupled to the power source. These prior art examples may use clips or magnets to keep the floor mat in the correct position for power transfer.

It would be an advantage over the prior art if the floor mat could be anchored into a desired position using any convenient means such as a clips or magnets, and yet still operate correctly even if the clips or magnets are not holding the floor mat in a precise position. In other words, it would be an advantage over the prior art if the floor mat could still receive power in order to be illuminated even if the floor mat is not being anchored in a precise location on the floor of the vehicle.

### BRIEF SUMMARY

The present invention is a system and method for providing a floor mat that uses wireless technology to power a floor mat lighting system disposed within a floor mat, wherein the need for precise alignment of the floor mat with a wireless power transmitter is no longer required, and wherein the floor mat may be positioned in a general area of use on a floor of a vehicle and will now tolerate displacement of the floor mat that will not interrupt power flow.

In a first aspect of the invention, a magnetic coupling source may be used in the floor of the vehicle that allows a more inexact placement of the floor mat while still maintaining power flow to the floor mat.

In a second aspect of the invention, a transmission coil controller may not be required for use of the floor mat, wherein the floor mat is illuminated whenever the floor mat is disposed on the magnetic coupling source and power is applied.

In a third aspect of the invention, the transmission coil controller may be disposed within the floor mat and may provide features for controlling the illumination of the floor mat.

In a fourth aspect of the invention, a switch may be provided in the floor mat or external to the floor mat for toggling power on and off to the floor mat.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a top view of a floor mat that is made in accordance with the embodiments of the invention.

FIG. 2 is a block diagram of the components of the first embodiment of the invention.

FIG. 3 is a block diagram of the components of the second embodiment of the invention.

FIG. 4 shows a portion of a vehicle floor on the driver's side, and the likely position of the floor mat.

FIG. 5 shows a top view of the floor mat and a portion of the vehicle floor with system components disposed in possible locations.

FIG. 6 is a block diagram showing possible power sources for the floor mat lighting system.

FIG. 7A is a possible layout of the transmission coils on the vehicle floor.

FIG. 7B is a possible layout of the transmission coils on the vehicle floor.

FIG. 7C is a possible layout of the transmission coils on the vehicle floor.

FIG. 7D is a possible layout of the transmission coils on the vehicle floor.

FIG. 7E is a possible layout of the transmission coils on the vehicle floor.

FIG. 8 is a bottom view of the floor mat showing possible locations of the receiving coil.

FIG. 9 is a block diagram of two floor mats wherein a first floor mat is powered and a second floor mat receives power from the first floor mat.

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

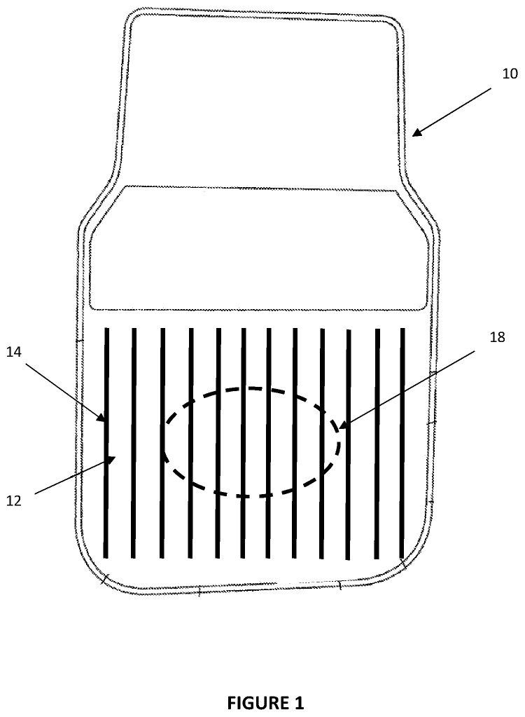

FIG. 1 is a top view of a floor mat 10. By its shape, this particular floor mat is designed for use in a front seating area of a vehicle. However, it should be understood that the floor mat may be shaped for use in a driver or passenger area of a vehicle, and for a front, middle, or a back seating area. The term “vehicle” should be considered to include any vehicle or trailer that may use a floor mat such as cars, trucks, SUVs, semi-trucks, recreational vehicles, etc. Thus, the shape of the floor mat is for illustration purposes only and should not be considered as limiting of the shape that the floor mat 10 may have in all the embodiments of the invention.

It should be understood that the floor mat 10 is comprised of an all-weather material such as rubber or a rubber-like material that can withstand the harsh environment of the floor of a vehicle. Ideally, the floor mat 10 is waterproof which serves to protect the vehicle but also the components within the floor mat.

The floor mat 10 may be used in an enclosed vehicle area as well as in an open vehicle or trailer. For example, the vehicle may be a recreational vehicle such as an ATV, UTV, snow mobile, motorhome, fifth wheel, bumper pull trailer, enclosed trailer, flatbed trailer, or any other recreational vehicle that may have a seating area or a cargo area.

Thus, while the invention may be referred to in its embodiments as a floor mat, it should be understood that the term “floor mat” may also refer to a cargo mat such as in the bed of a pickup truck or in the bed of a trailer, or a liner or decorative mat wherever a mat may be disposed in a vehicle.

While the floor mat 10 appears as a protective floor mat that protects a vehicle floor from wear and tear, the floor mat may serve any function or none at all and may be decorative in nature only.

In the first embodiment shown in FIG. 1, the floor mat 10 may include grooves 12 and ridges 14 that allow the collection or channeling of water, ice, snow or mud. Thus, the embodiments of the floor mat 10 may be considered to include waterproof or weatherproof lighting. This lighting may include at least one light source that is provided at one or more locations in the floor mat 10.

The locations of the lighting may be on a peripheral edge of the floor mat 10, in a specific designated area 18 such as an interior portion of the floor mat, or a combination of the peripheral edge and interior portion. The lighting may be within the grooves 12, on the ridges 14, or a combination thereof.

One of the main problems with floor mats is that they can be difficult to keep in a desired position on the vehicle floor. This is a natural consequence of a person pushing on the floor to adjust their seating position in a car seat or reaching for something in a vehicle and bracing their feet on the floor. Accordingly, many floor mats have holes that fit into a clip of some sort on the vehicle floor. However, holes can just be a point of leaking whatever fluid is currently in the groves of the floor mat 10 onto the vehicle floor. Thus, some all-weather floor mats may include no holes and rely on their size, shape, and/or weight to hold them in a generally desired position. Thus, all-weather floor mats are not always going to be in the same position on a vehicle floor and may be more than slightly askew from a desired position.

Accordingly, it is a feature of the embodiments of the invention to provide a system and method for ensuring that the floor mat 10 will receive uninterrupted wireless power for a floor mat lighting system disposed in the floor mat that does not depend on precise alignment with a wireless charging system disposed in the vehicle floor.

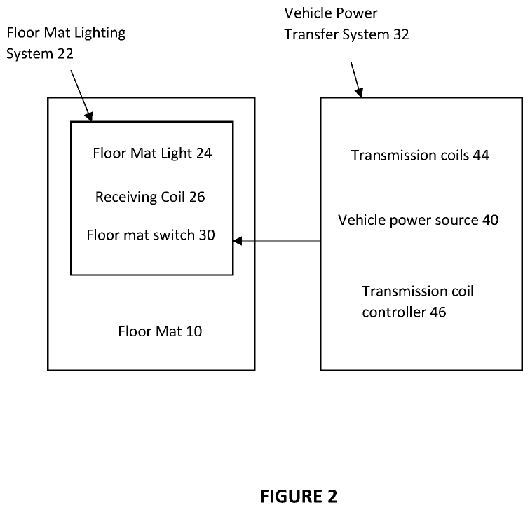

A first embodiment of the invention is shown in a block diagram in FIG. 2. The elements of the first embodiment include a floor mat lighting system 22 and a vehicle power transfer system 32.

The floor mat lighting system 22 is disposed in the floor mat 10. The floor mat lighting system 22 may include at least one floor mat light 24, a receiving coil 26, and a floor mat switch 30.

Complementary to this floor mat lighting system 22 is the vehicle power transfer system 32 that provides wireless power. The vehicle power transfer system 32 may include a plurality of separate transmission coils 44, a vehicle power source 40, and a transmission coil controller 46.

The at least one floor mat light 24 may include lighting technology such as LEDs, light pipes or any light source that may be disposed within and be visible from the floor mat 10. Additionally, a decorative image may be illuminated in the floor mat 10 to display a logo, a symbol, lettering, shapes, or other desired images. The floor mat 10 may include a branding image that is used to advertise a vehicle or other element of a vehicle.

The receiving coil 26 may be disposed on a bottom surface of the floor mat 10 so that it may be as close as possible to at least one of the plurality of transmission coils 44 in the vehicle floor 20. The receiving coil 26 may include some covering to protect it from damage and exposure to the elements.

The receiving coil 26 receives power wirelessly as will be explained. In the first embodiment of the invention, the power received by the receiving coil 26 is sent to the at least one floor mat light 24, but only if the floor mat switch 30 is in an “ON” or activated position. Power is not sent to the at least one floor mat light if the floor mat switch 30 is in an “OFF” or deactivated position.

The floor mat switch 30 may be disposed in the floor mat 10 in a location that is convenient and that will prevent damage thereto. For example, the switch may be a toggle switch on an edge of the floor mat 10 or a pressure switch that that is actuated by pressing on the floor mat in a specific location that is not likely to be stepped on unless it is a deliberate act. What is important is that in the first embodiment, the turning on or off of the floor mat 10 is a controllable action.

In the vehicle power transfer system 32, the transmission coil controller 46 may be used to selectively provide power to the transmission coils 44. The purpose for selectively controlling power to the transmission coils 44 is so that all of the transmission coils are not receiving power all of the time that the floor mat 10 is being illuminated. Thus, after determining which of the transmission coils 44 is providing power to the receiving coil 26, power can be removed from the remaining transmission coils.

As will be shown, there may be a plurality of transmission coils 44 that are provided for a single floor mat 10. Once it is determined which of the transmission coils 44 is providing power to the floor mat 10, the other transmission coils may be turned off. The transmission coil controller 46 may determine which transmission coils 46 are being used when the vehicle is started, or it may perform an assessment of the transmission coils at periodic intervals.

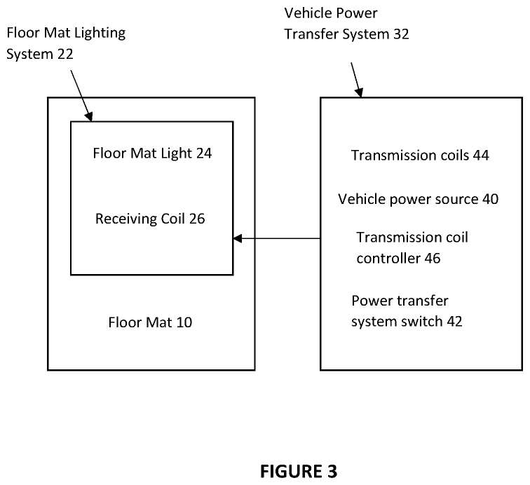

In a second embodiment of the floor mat lighting system 22 and the vehicle power transfer system 32, FIG. 3 shows in a block diagram that the system may include at least one floor mat light 24 and a receiving coil 26. However, in this embodiment there is no floor mat switch 30. This means that whenever power is provided to the floor mat lighting system 22, the floor mat 10 will be in an activated or ON state with no way to control the power on the floor mat 10 itself. However, the vehicle power transfer system 32 that transmits power to the floor mat 10 may or may not include a power transfer system switch 42. Thus, in the second embodiment, the floor mat switch 30 is moved from the floor mat 10 to the vehicle itself.

The transmission coil controller 46 may still provide the ability to turn off transmission coils 44 that are not being used by the floor mat 10.

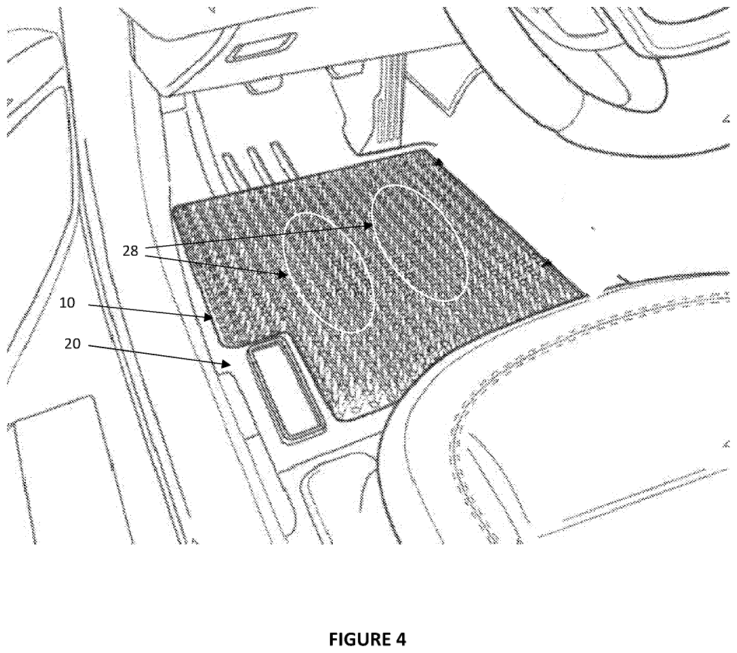

An important feature of all of the embodiments of the invention is the system and method of power transfer from the vehicle to the floor mat 10. FIG. 4 shows a portion of a vehicle floor 20 on the driver's side. It should be understood that this figure is for illustration purposes only, and that the features being shown may be adjusted within the parameters to be described herein.

FIG. 4 shows a typical position of a driver's feet as white ovals 28 on top of the floor mat 10 when the feet are not on the brake, the accelerator, or the clutch pedal of a vehicle.

In order to ensure that the floor mat 10 shown in FIG. 4 is always connected to wireless power, the prior art teaches that the floor mat must be firmly anchored into a correct position for inductive power transfer to occur. Some of the prior art requires magnets in the floor mat and the vehicle floor that must be magnetically coupled to each other for the floor mat to be in a correct position for power transfer. Another solution in the prior art teaches that an RFID chip in the floor mat 10 must provide confirmation that the floor mat is positioned properly. All of these alignment systems not only require extra components or introduce unnecessary complexity into a floor mat lighting system, but always require that the floor mat be in a precise position at all times.

Another teaching of the prior art is the use of a wired connection to the floor mat 10. There are numerous problems with a wired connection including such things as frayed wiring, broken wiring, and dirty connectors. The environment of a vehicle floor is typically such a dirty one that eliminating the use of exposed wiring is a substantial benefit to a floor mat lighting system.

Unfortunately, it is often the case that a floor mat does not stay in the exact same position on a vehicle floor when being used. For example, the driver may remove the floor mat for cleaning and not return it to the correct position or attach it properly to hooks in the vehicle floor. Even more often, the driver may push against the floor mat when getting into and out of the vehicle, resulting in the floor mat sliding out of a desired position. This is because the floor mat is typically not going to precisely fill all of the space at a driver or passenger's feet and is therefore prone to being moved.

Typical movement of a floor mat from a desired location may be described as being anywhere from 3 or 4 inches. The floor mat can slide up under the vehicle pedals, underneath the driver's seat, further towards the middle of the vehicle or towards the vehicle door, and also diagonally. Essentially, there is no direction that the floor mat cannot be pushed. However, eventually the stiffness of a floor mat and the physical dimensions of the vehicle floor underneath the driver may eventually stop the movement of the floor mat. Nevertheless, movement is typically normal even when hooks or other means are provided to impede floor mat movement.

Accordingly, the present invention reduces the complexity of the design of a floor mat lighting system 22 and a vehicle power transfer system 32 through the use of at least one grid of a plurality of small inductive power sources that are being referred to as the plurality of transmission coils 44 on the vehicle floor 20, a fewer larger transmission coils, or a combination of smaller and larger transmission coils.

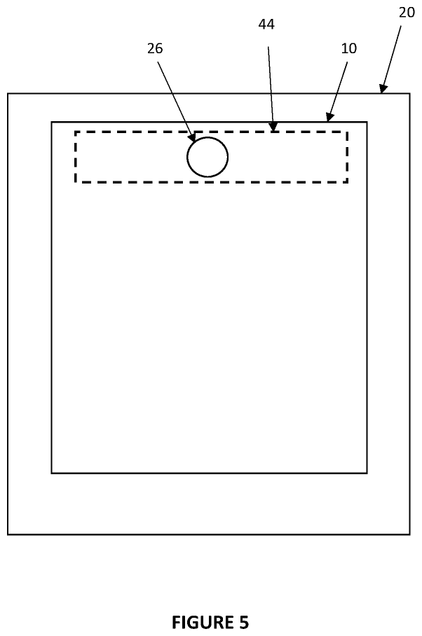

As shown in FIG. 5, the at least one grid of transmission coils 44 is disposed on, in, or under the vehicle floor 20 in such a manner that even if the floor mat 10 is somewhat askew or displaced from an optimal position, the floor mat is still likely to sufficiently overlap the transmission coils 44 and therefore be receiving power.

The vehicle floor 20 may be the structural floor of the vehicle but is more often going to be carpeting or some type of covering that is installed on top of the structural floor of a vehicle. Thus, the transmission coils 44 may be installed on top of the carpeting layer, between a top carpeting layer and a padded layer underneath, or completely under the carpeting layer and resting on the structural floor.

The at least one grid of transmission coils 44 are disposed on the vehicle floor 20 in a location that is most likely to intersect the receiving coil 26 on the floor mat 10. The at least one grid of transmission coils 44 may therefore be of a particular number, diameter, and position that will enable the receiving coil 26 on the floor mat 10 to sufficiently overlap the position of at least one of the transmission coils 44.

It is noted that there may not be a complete overlap of one of the transmission coils 44, but even a partial overlap may be sufficient to enable the transfer of power to the receiving coil 26.

The grid of transmission coils 44 may be comprised of a plurality of smaller transmission coils that are arranged in a grid pattern, or lined up in a row, column, or combination of rows and columns, and then powered individually or all at the same time. It should be understood that the scope of the embodiments of the invention include the concept that the actual shape of the transmission coils 44 or the specific layout that enables at least one of the transmission coils 44 to transfer energy to the receiving coil 26 may be modified as necessary from what is shown in the figures. What is important is that a grid of multiple transmission coils 44 be provided in some grid layout. The function of the grid is to increase the chances that at least one of the transmission coils 44 is at least partially overlapped by the receiving coil 26.

In an alternative embodiment, there may also be a plurality of receiving coils 26 in the floor mat 10 to thereby further increase the chances of a good power transfer to the floor mat 10.

Regarding the manner of power transfer from the vehicle to the floor mat 10, the inductive power transfer system that is being used in the embodiments of the invention generate a time-varying electromagnetic field which transmits power from a transmitting antenna or coil 44 to the receiving antenna or coil 26. The receiving coil 26 extracts power from the electromagnetic field and supplies it to an electrical load, as understood by those skilled in the art of wireless power transmission.

In this first embodiment, power is transmitted by one of the transmission coils 44 and received at a single receiving coil 26 disposed on top of or at least partially overlapping one of the transmission coils 44. Ideally, the receiving coil 26 is completely surrounded by one of the circular transmission coils 44. However, power transfer may still occur if one of the transmission coils 44 and the receiving coil 26 are at least partially overlapping.

Both the transmission coils 44 and the receiving coil 26 form a system of magnetically coupled inductors. An alternating current in at least one of the transmission coils 44 generates a magnetic field which induces a voltage in the receiving coil 26. This voltage may be used to power the floor mat lighting system 22 directly, or through the charging of a battery in the floor mat 10.

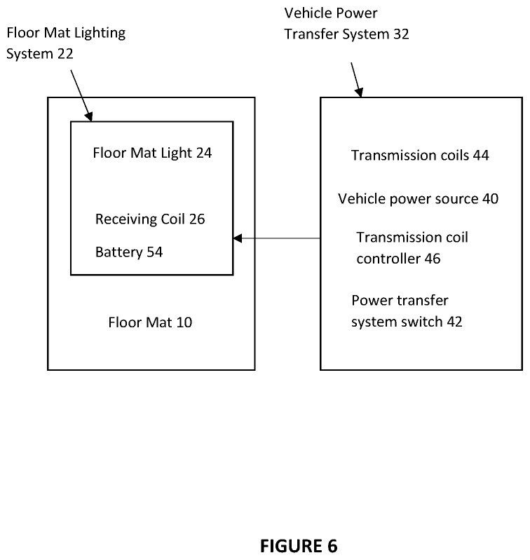

Accordingly, as shown in FIGS. 5 and 6, it should be understood that the floor mat lighting system 22 may be powered directly from the receiving coil 26, or from a battery 54 in the floor mat 10. The battery 54 may be charged by the receiving coil 26 or the battery may be replaceable and charged externally from the floor mat 10.

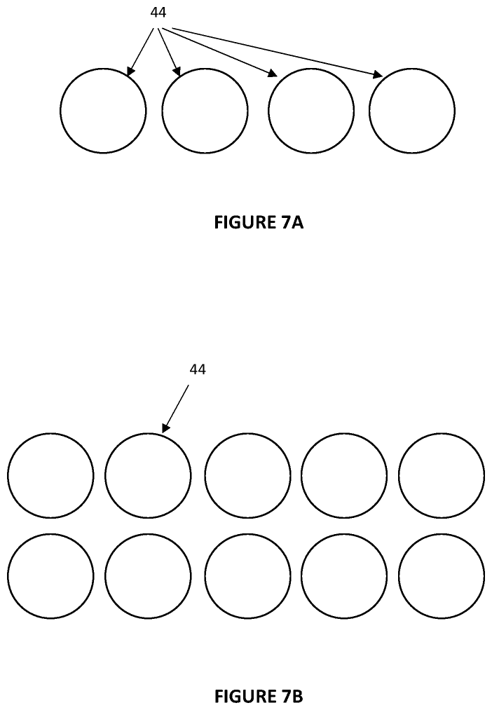

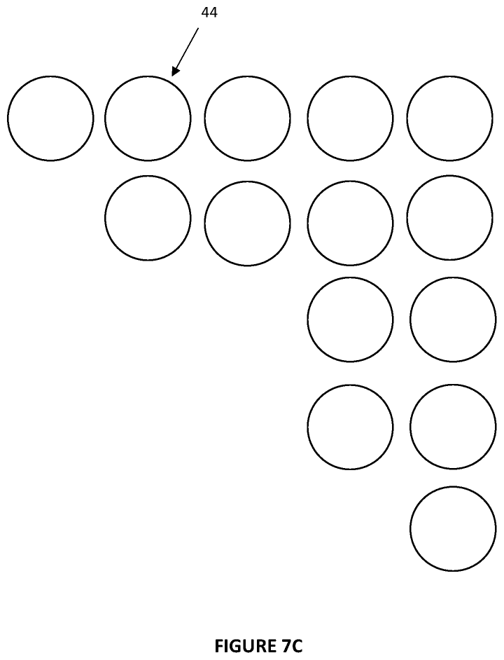

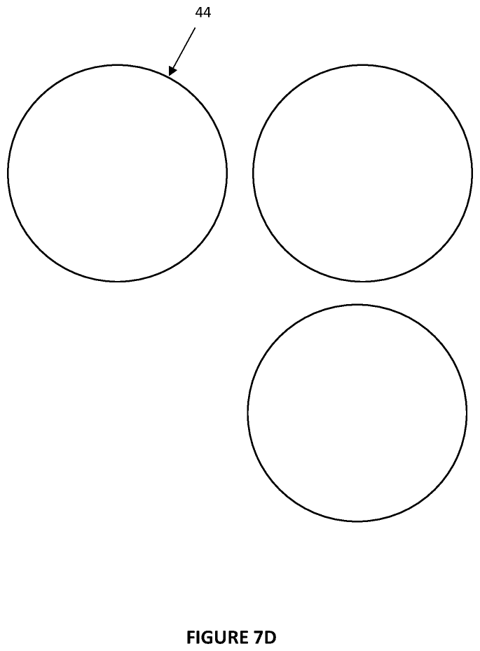

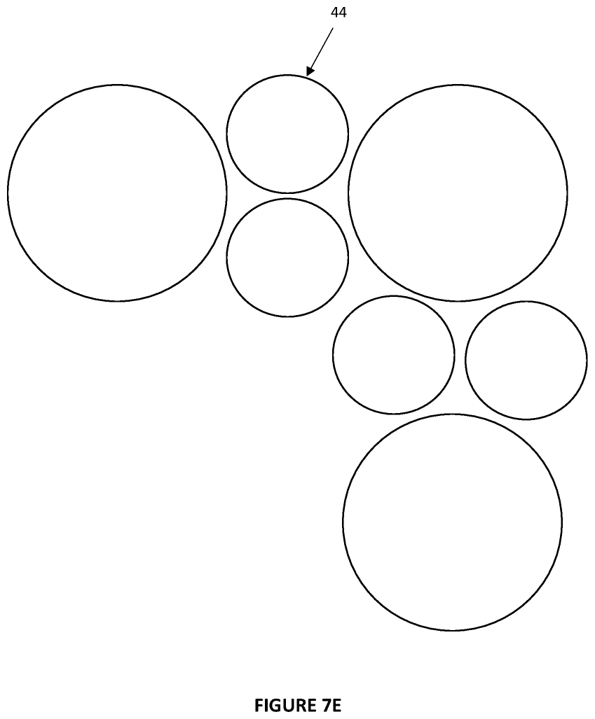

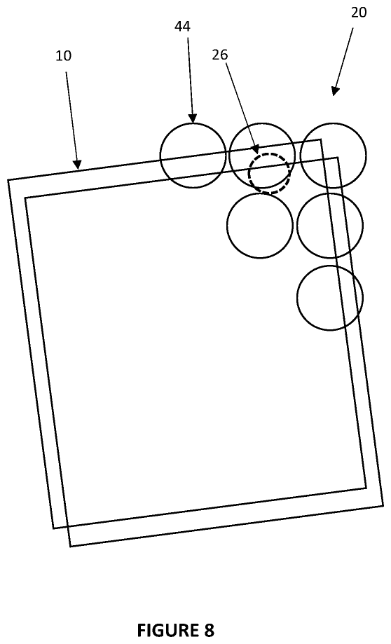

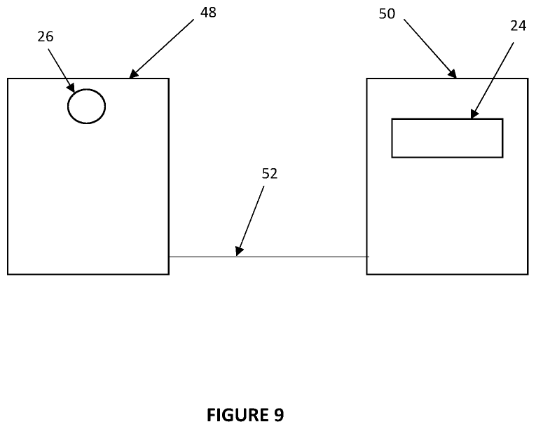

FIGS. 7A to 7E are provided as a plurality of examples of possible grid patterns of the transmission coils 44. However, these figures should not be considered to be an exhaustive illustration of all possible layouts of the transmission coils, but only some possible examples.

For example, FIG. 7A shows that the transmission coils 44 may be lined up in a single row comprised of four transmission coils 44. FIG. 7B shows that the transmission coils 44 may be lined up in two rows of transmission coils 44. FIG. 7C shows that the transmission coils 44 may be lined up in a combination of rows and columns, with a variable number of transmission coils in different rows and columns. FIG. 7D shows that the transmission coils 44 may be comprised of just larger transmission coils 44. FIG. 7E shows that the transmission coils 44 may be comprised of a combination of larger transmission coils and smaller transmission coils. It should be understood that the grid patterns shown in FIGS. 6A to 6E are examples only, and any suitable grid pattern for the transmission coils 44 may be selected. This includes changing the number of transmission coils 44 in each row and/or column.

It should be observed that the transmission coils 44 are also arranged so as to be separated from the usual placement of a person's feet while seated in the driver's seat. Accordingly, a preferred position for the transmission coils 44 is to be disposed underneath the pedals where a driver's feet are not going to be placed during normal operation of a vehicle. However, it should be recognized that placement of the transmission coils 44 under any of the corners or a particular edge of the floor mat 10 may be suitable locations.

FIG. 8 is a view of the floor mat 10 on top of the vehicle floor 20 and also showing the position of one possible layout of six transmission coils 44 in an upper right corner of the vehicle floor. This view shows a receiving coil 26 in outline through the floor mat 10. The floor mat 10 is also shown being askew relative to the vehicle floor 20 because floor mats are often pushed and moved from a desired position. The receiving coil 26 may be disposed in any desired location in the floor mat 10 as outlined, as long as that location in the floor mat corresponds to the general placement of the transmission coils 44 on the vehicle floor 20. However, placement of the receiving coil 26 is also important so that the receiving coil will always be at least partially overlapping at least one of the transmission coils 44.

It should be apparent from FIGS. 7A to 7E and from FIG. 8 that even if the floor mat 10 is slightly askew or displaced from an ideal power transfer position on the vehicle floor 20, the floor mat only has to be in generally the correct area of the vehicle floor in order for the receiving coil 26 to overlap at least one of the transmission coils 44 sufficient to enable a power transfer to the floor mat lighting system 22.

It is also a feature of the embodiments of the invention that the transmission coils 44 may not all be providing power at the same. For example, the transmission coils 44 may each be energized sequentially until the floor mat lighting system 22 is operating which may be recognized by the transmission coils 44 because of an electrical load on the vehicle power transfer system 32. The sequential energizing of the transmission coils 44 may then be terminated and the single transmission coil that is energized and providing power to the floor mat lighting system 22 would then remain on.

It is anticipated that when the vehicle is first started that the sequential energizing of the transmission coils 44 in the first embodiment would begin and continue providing sequential power until the floor mat lighting system is operational. For example, each of the transmission coils 44 could be energized for two seconds until all of the transmission coils 44 have been energized. The pattern of energizing the transmission coils 44 may then be repeated for a period of time if it is detected that the floor mat lighting system 22 was not being powered. The vehicle driver could make a slight adjustment to the position of the floor mat 10 until it was finally powered on.

Alternatively, all of the transmission coils 44 could all be energized at the same time and thus making certain that the floor mat lighting system 22 is receiving power. The vehicle transfer power system 32 could then turn off all of the other transmission coils 44 that are not providing power to the floor mat 10 leaving the single transmission coil 44 energized that is providing power to the floor mat lighting system 22.

In summary regarding the apparatus of the vehicle illumination system, the vehicle illumination system is comprised of a floor mat lighting system and a vehicle power transfer system.

More specifically, the floor mat lighting system includes a floor mat having a peripheral edge and a plurality of groves and ridges therein, at least one floor mat light that is disposed on a top side or within the floor mat but visible on a top side, a receiving coil disposed on a bottom side or within the floor mat, and a floor mat switch in the floor mat that enables power received by the receiving coil to be terminated or directed to the at least one floor mat light.

The vehicle power transfer system is comprised of a vehicle power source, and a plurality of transmission coils, wherein the plurality of transmission coils is electrically coupled via a wire to the vehicle power source, and wherein the receiving coil is disposed so as to at least partially overlap at least one of the plurality of transmission coils.

Also, in summary, a method for providing a vehicle illumination system comprises the steps of first providing a floor mat lighting system wherein said floor mat lighting system is comprised of a floor mat, at least one floor mat light that is disposed on a top side or within the floor mat but visible on a top side, a receiving coil disposed on a bottom side or within the floor mat, and a floor mat switch in the floor mat.

Likewise, providing the vehicle power transfer system comprises the steps of providing a vehicle power source and a plurality of transmission coils, wherein the plurality of transmission coils is electrically coupled via a wire to the vehicle power source.

The next step is that of disposing the plurality of transmission coils in a pattern on a vehicle floor, then disposing the floor mat on the vehicle floor such that the receiving coil is at least partially overlapping at least one of the plurality of transmission coils, then turning the floor mat switch to an ON position, and then energizing the plurality of transmission coils so that power is transferred to the receiving coil, and thereby causing the at least one light to receive power and illuminate the vehicle.

As shown in FIG. 8, in a third embodiment, the two floor mats 10 may be disposed in a front driver and passenger area of a vehicle, or in a rear passenger only area of the vehicle. What is important to notice is that a first floor mat 48 includes a receiving coil 26 for receiving power from the vehicle power transfer system 32. However, a second floor mat 50 does not include a receiving coil. Instead, a power transfer cable 52 is disposed between the first floor mat 48 and the second floor mat 50 for sending power to the floor mat light 24 disposed in the second floor mat. Thus, the second floor 50 mat does not require the complete floor mat lighting system 22 of the first floor mat 48.

The power transfer cable 52 may use any convenient connection system on the floor mats 10. For example, the power transfer cable 52 may use a friction fit so that it may slide in and out of the floor mats 48,50. This type of connection may prevent damage to the power transfer cable 52 and to the floor mats 10 if the power transfer cable is not first disconnected before removing a floor mat from a vehicle.

Similarly, a power transfer cable 52 may also be disposed to direct power to floor mats that may be behind the front driver and passenger area of the vehicle. Thus, floor mats may be equipped with one or more power connectors so that they may be connected to an adjacent floor mat that is on any side.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A vehicle illumination system comprising:
a floor mat lighting system, said floor mat lighting system comprised of:
a floor mat having a peripheral edge and a plurality of groves and ridges therein;
at least one floor mat light that is disposed on a top side or within the floor mat but visible on a top side,
a receiving coil disposed on a bottom side or within the floor mat;
a floor mat switch in the floor mat that enables power received by the receiving coil to be terminated or directed to the at least one floor mat light;
a vehicle power transfer system, said vehicle power transfer system comprised of:
a vehicle power source; and
a plurality of transmission coils, wherein the plurality of transmission coils is electrically coupled via a wire to the vehicle power source;
wherein the receiving coil is disposed so as to at least partially overlap at least one of the plurality of transmission coils.

2. The vehicle illumination system as defined in claim 1 wherein the floor mat is comprised of rubber or a rubber-like material so that it is waterproof.

3. The vehicle illumination system as defined in claim 1 wherein the at least one floor mat light is comprised of at least one LED light.

4. The vehicle illumination system as defined in claim 1 wherein the receiving coil receives power from at least one of the plurality of transmission coils are magnetically coupled so that the receiving coil receives power from at least one of the plurality of transmission coils using an inductive power transfer of energy.

5. The vehicle illumination system as defined in claim 1 wherein the floor mat switch is selected from the group of switches comprised of pressure switches and mechanical toggle switches.

6. The vehicle illumination system as defined in claim 1 wherein the vehicle power source is comprised of a vehicle electrical system.

7. The vehicle illumination system as defined in claim 1 wherein the vehicle power transfer system is further comprised of a transmission coil controller that selectively controls power to each of the plurality of transmission coils.

8. A vehicle illumination system comprising:
a floor mat lighting system, said floor mat lighting system comprised of:
a floor mat having a peripheral edge and a plurality of groves and ridges therein;
at least one floor mat light that is disposed on a top side or within the floor mat but visible on a top side,
a receiving coil disposed on a bottom side or within the floor mat;
a vehicle power transfer system, said vehicle power transfer system comprised of:
a vehicle power source;
a plurality of transmission coils, wherein the plurality of transmission coils is electrically coupled via a wire to the vehicle power source;
a power transfer system switch in the vehicle that enables power to be terminated or to be received by the plurality of transmission coils; and
wherein the receiving coil is disposed so as to at least partially overlap at least one of the plurality of transmission coils.

9. A method for providing a vehicle illumination system, said method comprising:
providing a floor mat lighting system wherein said floor mat lighting system is comprised of a floor mat, at least one floor mat light that is disposed on a top side or within the floor mat but visible of a top side, a receiving coil disposed on a bottom side or within the floor mat, and a floor mat switch in the floor mat;
providing a vehicle power transfer system wherein said vehicle power transfer system is comprised of a vehicle power source and a plurality of transmission coils, wherein the plurality of transmission coils is electrically coupled via a wire to the vehicle power source;
disposing the plurality of transmission coils in a pattern on a vehicle floor;
disposing the floor mat on the vehicle floor such that the receiving coil is at least partially overlapping at least one of the plurality of transmission coils;
turning the floor mat switch to an activated position; and
energizing the plurality of transmission coils so that power is transferred to the receiving coil, and thereby causing the at least one light to receive power and illuminate the vehicle.

10. The method for providing illumination in a vehicle as defined in claim 9 wherein the method further comprises wirelessly transferring power from the plurality of transmission coils to the receiving coil.

11. The method for providing illumination in a vehicle as defined in claim 10 wherein the method further comprises inductively transferring power from the plurality of transmission coils to the receiving coil.

12. The method for providing illumination in a vehicle as defined in claim 11 wherein the method further comprises:
providing a transmission coil controller that selectively controls power to each of the plurality of transmission coils;
determining which one of the plurality of transmission coils is providing power to the receiving coil; and
removing vehicle power from all of the plurality of transmission coils that are not providing power to the receiving coil using the transmission coil controller.

13. The method for providing illumination in a vehicle as defined in claim 12 wherein the method further comprises:
selectively providing power to each of the plurality of transmission coils one at a time for a period time;
determining which one of the plurality of transmission coils is providing power to the receiving coil; and
removing vehicle power from all of the plurality of transmission coils that are not providing power to the receiving coil using the transmission coil controller.

14. A method for providing a vehicle illumination system, said method comprising:
providing a floor mat lighting system wherein said floor mat lighting system is comprised of a floor mat, at least one floor mat light that is disposed on a top side or within the floor mat but visible of a top side, and a receiving coil disposed on a bottom side or within the floor mat;
providing a vehicle power transfer system wherein said vehicle power transfer system is comprised of a vehicle power source and a plurality of transmission coils, a power transfer system switch in the vehicle that enables power to be terminated or to be received by the plurality of transmission coils, and wherein the plurality of transmission coils is electrically coupled via a wire to the vehicle power source;
disposing the plurality of transmission coils in a pattern on a vehicle floor;
disposing the floor mat on the vehicle floor such that the receiving coil is at least partially overlapping at least one of the plurality of transmission coils;
turning the power transfer system switch to an ON position; and
energizing the plurality of transmission coils so that power is transferred to the receiving coil, and thereby causing the at least one light to receive power and illuminate the vehicle.

15. The method for providing illumination in a vehicle as defined in claim 14 wherein the method further comprises wirelessly transferring power from the plurality of transmission coils to the receiving coil.

16. The method for providing illumination in a vehicle as defined in claim 15 wherein the method further comprises inductively transferring power from the plurality of transmission coils to the receiving coil.

17. The method for providing illumination in a vehicle as defined in claim 16 wherein the method further comprises:
providing a transmission coil controller that selectively controls power to each of the plurality of transmission coils;
determining which one of the plurality of transmission coils is providing power to the receiving coil; and
removing vehicle power from all of the plurality of transmission coils that are not providing power to the receiving coil using the transmission coil controller.

18. The method for providing illumination in a vehicle as defined in claim 17 wherein the method further comprises:
selectively providing power to each of the plurality of transmission coils one at a time for a period time;
determining which one of the plurality of transmission coils is providing power to the receiving coil; and
removing vehicle power from all of the plurality of transmission coils that are not providing power to the receiving coil using the transmission coil controller.
